(19) United States
(12) Patent Application Publication
(10) Pub. No.: US 2024/0397384 A1
(43) Pub. Date: Nov. 28, 2024

(54) INFORMATION TRANSMISSION METHOD AND APPARATUS, TERMINAL, AND STORAGE MEDIUM

(71) Applicant: VIVO MOBILE COMMUNICATION CO., LTD., Dongguan (CN)

(72) Inventors: Yuming YANG, Dongguan (CN); Zichao JI, Dongguan (CN); Shuyan PENG, Dongguan (CN); Huan WANG, Dongguan (CN)

(73) Assignee: VIVO MOBILE COMMUNICATION CO., LTD., Dongguan (CN)

(21) Appl. No.: 18/786,393

(22) Filed: Jul. 26, 2024

Related U.S. Application Data
(63) Continuation of application No. PCT/CN2023/073550, filed on Jan. 28, 2023.

(30) Foreign Application Priority Data
Jan. 28, 2022 (CN) 202210108774.0

(51) Int. Cl. H04W 28/16; H04L 5/00; H04W 48/18

(52) U.S. Cl. CPC H04W 28/16; H04L 5/0048; H04W 48/18

(57) ABSTRACT

An information transmission method, a terminal, and a non-transitory computer-readable storage medium are provided. The information transmission method includes: sending, by a first terminal, control information. The control information includes request information or coordination information.

### CROSS-REFERENCE TO RELATED APPLICATIONS

This application is a continuation of International Application No. PCT/CN2023/073550, filed on Jan. 28, 2023, which claims priority to Chinese Patent Application No. 202210108774.0, filed on Jan. 28, 2022. The entire contents of each of the above-referenced applications are expressly incorporated herein by reference.

### TECHNICAL FIELD

This application relates to the field of communication technologies, and specifically, to an information transmission method and apparatus, a terminal, and a storage medium.

### BACKGROUND

In New Radio (NR) Sidelink (SL), a terminal may send request information to another terminal to request the another terminal to feedback coordination information, to complete SL establishment. The terminals may send the request information and the coordination information by using 2^{nd} Sidelink Control Information (SCI) and/or a Media Access Control Control Element (MAC CE).

However, there is currently no specific solution to how to transmit the request information and the coordination information.

### SUMMARY

Embodiments of this application provide an information transmission method and apparatus, a terminal, and a storage medium.

According to a first aspect, an information transmission method is provided. The method includes:
sending, by a first terminal, control information, where
the control information includes request information and/or coordination information.

In some embodiments, the control information includes at least one of the following indication information:
resource selection window indication information;
start time location indication information of a resource selection window;
end time location indication information of the resource selection window;
indication information of a maximum number of reserved periods for resource selection;
indication information of a number of subchannels occupied by sending data;
remaining Packet Delay Budget (PDB) indication information; or
first resource location indication information.

In some embodiments, the resource selection window indication information is determined by using at least one of the following:
a first reference location;
a start time location of the resource selection window;
an end time location of the resource selection window;
a third time unit offset, where the third time unit offset is a time unit offset relative to the start time location of the resource selection window or the first reference location; or
a Resource Indication Value (RIV).

In some embodiments, the start time location and/or the end time location of the resource selection window is indicated by at least one of the following:
a Direct Frame Number (DFN);
a time unit index within a radio frame; or
a fourth time unit offset, where the fourth time unit offset is a time unit offset relative to the first reference location.

In some embodiments, the first reference location is at least one of the following:
a location whose DFN is 0 and time unit index is 0;
the 1^{st} time unit location of a DFN in which the start time location of the resource selection window is located;
a time location for transmitting the control information; or
a location following, by M time units, the time location for transmitting the control information, where M is predefined in a protocol, preconfigured on a network, or configured on the network.

In some embodiments, a resource selection window indicated by the resource selection window indication information meets at least one of the following:
a size that is of the resource selection window and that is predefined in a protocol, preconfigured on a network, or configured on the network is maximally Wₘₐₓ; or
a size that is of the resource selection window and that is predefined in a protocol, preconfigured on a network, or configured on the network is minimally Wₘᵢₙ, where

$${W}_{min} \leq L \leq T 1 + {W}_{max} - {T}_{start} ; and$$

$${W}_{min} \leq L \leq T 1 - {T}_{start} ,$$

where
L is a time unit offset, Wₘᵢₙ is a minimum value of the time unit offset, T1 is an indication range of 1024 radio frames, and Tₛₜₐᵣₜ is a start time location of the resource selection window.

In some embodiments, the RIV is determined by using at least one of the following:

$$RIV = S ( L - {W}_{min} ) + {T}_{start} ;$$

$$RIV = L ;$$

$$RIV = \{ \begin{matrix}S ( L - {W}_{min} ) + {T}_{start} , & ( L - {W}_{min} ) \leq ⌊ S / 2 ⌋ \\ S ( S - L + {W}_{min} ) + ( S - 1 - {T}_{start} ) , & ( L - {W}_{min} ) > ⌊ S / 2 ⌋\end{matrix} ;$$

$$RIV = {W}_{max} {t}_{3} + {t}_{4} ;$$

$$RIV = {W}_{max} ( {t}_{4} - {t}_{3} - 1 ) - {t}_{3} ; or$$

$$RIV = \{ \begin{matrix}( {W}_{max} - 1 ) ( {t}_{2} - {t}_{1} - 1 ) + {t}_{1} + {W}_{max} , & ( {t}_{2} - {t}_{1} - 1 ) < ⌊ {W}_{max} / 2 ⌋ \\ ( {W}_{max} - 1 ) ( {W}_{max} - {t}_{2} + {t}_{1} ) + 2 {W}_{max} - {t}_{1} , & ( {t}_{2} - {t}_{1} - 1 ) \geq ⌊ {W}_{max} / 2 ⌋\end{matrix} ,$$

where
S=T1+Wₘₐₓ, T1 is an indication range of 1024 radio frames, Wₘₐₓ is a maximum value of a size of the resource selection window, L is a time unit offset, Tₛₜₐᵣₜ is the start time location of the resource selection window, Wₘᵢₙ is a minimum value of the size of the resource selection window, t₃ is a time unit offset of the start time location of the resource selection window relative to the first reference location, and t₄ is a time unit offset of the end time location of the resource selection window relative to the first reference location.

In some embodiments, the first resource location indication information indicates first resource locations of N Time Resource Indication Values (TRIVs), where N is a positive integer.

In some embodiments, the first resource location indication information meets at least one of the following:
a number that is of bits of the first resource location indication information and that is predefined in a protocol is L_{bit};
in the first resource location indication information, a number of bits indicating a first resource location of the 1^{st} TRIV is L1, a number of bits indicating a first resource location of the 2^{nd} TRIV is L2, and a number of bits indicating a first resource location of the 3^{rd} TRIV is L3, where L1+L2+L3=L_{bit};
the first resource location of the 1^{st} TRIV is indicated by a time unit offset relative to a second reference location, and a first resource location of a TRIV other than the 1^{st} TRIV is indicated by a time unit offset to a last actual indicated time unit in an immediate previous TRIV;
the N first resource locations are indicated by time unit offsets relative to the second reference location;
the first resource location of the 1^{st} TRIV is indicated based on the second reference location and/or a first time unit offset;
the first resource location of the 2^{nd} TRIV is indicated based on the second reference location and/or a second time unit offset; or
it is predefined in a protocol, preconfigured on a network, or configured on the network that the first resource location of the 1^{st} TRIV is an x^{th} time unit after the second reference location, where
L_{bit}, L1, L2, L3, N, and x are all positive integers.

In some embodiments, the first time unit offset is predefined in a protocol, preconfigured on the network, or configured on the network; and
the second time unit offset is predefined in a protocol, preconfigured on the network, or configured on the network.

In some embodiments, a maximum value of the first time unit offset is predefined in a protocol, preconfigured on the network, or configured on the network; or
a maximum value of the second time unit offset is predefined in a protocol, preconfigured on the network, or configured on the network.

In some embodiments, an index indication range of the first time unit offset includes all or a part of time unit locations within all or a part of DFNs; or
an index indication range of the second time unit offset includes all or a part of time unit locations within all or a part of DFNs.

In some embodiments, an index indication range of the second reference location includes all time unit locations within all DFNs.

In some embodiments, the first resource location indication information meets at least one of the following:
N is equal to 2 or 3; or
the first resource location is indicated by a time unit offset relative to a second reference location.

In some embodiments, the second reference location is at least one of the following:
a location whose DFN is 0 and time unit index is 0;
the 1^{st} time unit location of a DFN in which the start time location of the resource selection window is located;
the start time location of the resource selection window;
a last actual indicated time unit in the 1^{st} TRIV;
a time location for transmitting the control information;
a location following, by M time units, the time location for transmitting the control information, where M is predefined in a protocol, preconfigured on a network, or configured on the network;
a start location of a resource selection period;
a last actual indicated time unit in an immediate previous TRIV; or
a first resource location of the immediate previous TRIV.

In some embodiments, a maximum value of the second reference location is predefined in a protocol, preconfigured on the network, or configured on the network.

In some embodiments, in a case that first resource locations of the first two TRIVs are indicated in a RIV form, a first resource location of the 3^{rd} TRIV is indicated by a time unit offset relative to a last actual indicated time unit in an immediate previous TRIV; or
in a case that first resource locations of last two TRIVs are indicated in a RIV form, a first resource location of the 1^{st} TRIV is indicated by a time unit offset relative to the second reference location.

In some embodiments,

$$RIV = \{ \begin{matrix}( K - 1 ) ( {t}_{2} - {t}_{1} - 1 ) + {t}_{1} + K , & {t}_{2} - {t}_{1} - 1 \leq ⌊ K / 2 ⌋ \\ ( K - 1 ) ( K - {t}_{2} + {t}_{1} ) + 2 ( K ) - {t}_{1} , & {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on a network, or configured on the network;
a time unit offset of an end time location of the resource selection window relative to the second reference location; or
the time unit offset of the end time location of the resource selection window relative to the second reference location minus processing time.

In some embodiments, in a case that N is equal to 2,

$$RIV = \{ \begin{matrix}( K - 1 ) ( {t}_{2} - {t}_{1} - 1 ) + {t}_{1} + K , & {t}_{2} - {t}_{1} - 1 \leq ⌊ K / 2 ⌋ \\ ( K - 1 ) ( K - {t}_{2} + {t}_{1} ) + 2 ( K ) - {t}_{1} , & {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on a network, or configured on the network;
a time unit offset of an end time location of the resource selection window relative to the second reference location; or
the time unit offset of the end time location of the resource selection window relative to the second reference location minus processing time.

In some embodiments, the first resource location indication information indicates first resource locations of two TRIVs in a RIV form.

In some embodiments, the first resource location indication information meets at least one of the following:
a first resource location of the 1^{st} TRIV is indicated by a time unit offset relative to a second reference location;
a first resource location of the 2^{nd} TRIV is indicated by a time unit offset relative to a last actual indicated time unit in the 1^{st} TRIV;
a first resource location of the 3^{rd} TRIV is indicated by a time unit offset relative to a last actual indicated time unit in the 2^{nd} TRIV;
first resource locations of two TRIVs are indicated by time unit offsets relative to the second reference location; or
t₁<t₂≤X, where X=2^{(B+1)/2}, t₁ is the time unit offset of the first resource location of the 1^{st} TRIV relative to the second reference location, t₂ is a time unit offset of the first resource location of the 2^{nd} TRIV relative to the second reference location or the time unit offset of the first resource location of the 2^{nd} TRIV relative to the last actual indicated time unit in the 1^{st} TRIV, or is a time unit offset of the first resource location of the 3^{rd} TRIV relative to the second reference location or the time unit offset of the first resource location of the 3^{rd} TRIV relative to the last actual indicated time unit in the second TRIV, and B is a number that is of bits of a TRIV and that is preconfigured or configured on a network.

In some embodiments,

$$RIV = \{ \begin{matrix}( X - 1 ) ( {t}_{2} - {t}_{1} - 1 ) + {t}_{1} + X , & {t}_{2} - {t}_{1} - 1 \leq ⌊ X / 2 ⌋ \\ ( X - 1 ) ( X - {t}_{2} + {t}_{1} ) + 2 ( X ) - {t}_{1} , & {t}_{2} - {t}_{1} - 1 > ⌊ X / 2 ⌋\end{matrix}$$

In some embodiments, in a case that a first identifier in the control information indicates that the control information includes the coordination information, A^{th} to C^{th} bits in the control information are resource combination indication information; or when a first identifier in the control information indicates that the control information includes the request information, A^{th} to C^{th} bits in the control information include at least one of the following indication information:
start time location indication information of a resource selection window;
end time location indication information of the resource selection window;
indication information of a maximum number of reserved periods for resource selection;
indication information of a number of subchannels occupied by sending data; or
remaining PDB indication information.

According to a second aspect, an information transmission apparatus is provided, including:
a first sending module, used by a first terminal to send control information, where
the control information includes request information and/or coordination information.

According to a third aspect, a terminal is provided. The terminal includes a processor and a memory. The memory stores a program or instructions runnable on the processor, and the program or the instructions, when executed by the processor, implement the method according to the first aspect.

According to a fourth aspect, a readable storage medium is provided. The readable storage medium stores a program or instructions, where the program or the instructions, when executed by a processor, implement the method according to the first aspect.

According to a fifth aspect, a chip is provided. The chip includes a processor and a communication interface, the communication interface is coupled to the processor, and the processor is configured to run a program or instructions to implement the method according to the first aspect.

According to a sixth aspect, a computer program/program product is provided. The computer program/program product is stored in a storage medium, and is executed by at least one processor to implement the method according to the first aspect.

In embodiments of this application, the first terminal sends the control information to a second terminal, where the control information includes the request information and/or the coordination information.

### BRIEF DESCRIPTION OF THE DRAWINGS

FIG. 1 is a schematic diagram of a wireless communication system to which an embodiment of this application is applicable;

FIG. 2 is a schematic diagram of an information transmission method according to an embodiment of this application;

FIG. 3 is a schematic diagram of an indication principle for a resource selection window according to an embodiment of this application;

FIG. 4 is a schematic diagram 1 of an indication principle for a first resource location according to an embodiment of this application;

FIG. 5 is a schematic diagram 2 of an indication principle for a first resource location according to an embodiment of this application;

FIG. 6 is a schematic diagram of an information transmission apparatus according to an embodiment of this application; and

FIG. 7 is a schematic diagram of a structure of terminal according to an embodiment of this application.

### DETAILED DESCRIPTION

Technical solutions in embodiments of this application are clearly described in the following with reference to the accompanying drawings in the embodiments of this application. Apparently, described embodiments are merely some rather than all of the embodiments of this application. All other embodiments obtained by a person of ordinary skill in the art based on the embodiments of this application fall within the protection scope of this application.

Terms such as “first” and “second” in this specification and the claims of this application are used to distinguish similar objects, but are not used to describe a specific sequence or order. It should be understood that terms used in this way are exchangeable in a proper case, so that the embodiments of this application can be implemented in an order different from the order shown or described herein. In addition, objects distinguished by using “first” and “second” are usually of a same category, and a number of objects is not limited. For example, there may be one or more first objects. In addition, “and/or” used in this specification and the claims represents at least one of connected objects, and the character “/” usually indicates that there is an “or” relationship between associated objects.

It should be noted that technologies described in the embodiments of this application are not limited to a Long Term Evolution (LTE)/LTE-Advanced (LTE-A) system, and may further be applied to other wireless communication systems such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency Division Multiple Access (SC-FDMA) system, and other systems. The terms “system” and “network” in the embodiments of this application are usually interchangeably used, and the described technology can be applied to the systems and radio technologies mentioned above, and can also be applied to other systems and radio technologies. The following describes an NR system as an example, and NR terms are used in most of the following descriptions. However, these technologies can also be applied to systems other than the NR system, such as a 6th Generation (6G) communication system.

FIG. 1 is a schematic diagram of a wireless communication system to which an embodiment of this application is applicable. As shown in FIG. 1, the wireless communication system includes an access network device and a terminal/User Equipment (UE), links between the UE and the access network device include an Uplink (UL) and a Downlink (DL), and a link between UEs is a Sidelink (SL). The UE may be a terminal side device, for example, a mobile phone, a tablet personal computer, a laptop computer, which is referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a Vehicle User Equipment (VUE), a Pedestrian User Equipment (PUE), a smart home (a household device, for example, a refrigerator, a television, a washing machine, or furniture, having a wireless communication function), a game machine, a Personal Computer (PC), a teller machine, or a self-service machine. The wearable device includes: a smartwatch, a smartband, smart headphones, smartglasses, smart jewelry (a smart bracelet, a smart ring, a smart necklace, a smart anklet, or the like), a smart wristband, smart clothing, or the like.

It should be noted that, a specific type of the UE is not limited in the embodiments of this application. A network side device may include the access network device or a core network device. The access network device may also be referred to as a radio access network device, a Radio Access Network (RAN), a radio access network function, or a radio access network unit. The access network device may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNB, a Transmission Reception Point (TRP), or another appropriate terminology in the field. The base station is not limited to a particular terminology, provided that same technical effects are achieved. It should be noted that a base station in the NR system is merely used as an example in the embodiments of this application, and a specific type of the base station is not limited.

In NR SL, a terminal may send request information to another terminal to request the another terminal to feed back coordination information, to complete SL establishment. The terminals may send the request information and the coordination information by using 2^{nd} SCI and/or an MAC CE, and may indicate a start time location/an end time location of a resource selection window in the 2^{nd} SCI and/or the MAC CE. The following two solutions may be included:
1. When a first resource location is indicated in the 2^{nd} SCI, a solution of a preset value is adopted, so that the UE selects one value from limited configuration information as a first resource location of one TRIV, or multiplies the value by a specific preset value to obtain a value as a first resource location of one TRIV. Although a number of occupied bits is small in this solution, the first resource location of each TRIV cannot indicate an actual resource location and can only function as a reference location. This results in low resource utilization. In some alternative embodiments, even though the first resource location may indicate an actual resource location, because the preset value is used, both an indicated range and selection of a resource indicated in the TRIV are limited.
2. A first resource location of a TRIV other than the 1^{st} TRIV is indicated by a slot offset to a last actual indicated slot in an immediate previous TRIV (Slot offset to the last actual indicated slot in immediate previous TRIV for other TRIV). In this case, a location of a selected resource is not determined due to an indefinite range of a selection window, and indication information needs to be designed to indicate a maximum range. Therefore, a number of needed bits is still related to a maximum selection window size that can be configured, and is not reduced because of use of the slot offset. Therefore, although most resource locations can be indicated in this solution, a sufficient budget needs to be provided for the indication information during design of the 2^{nd} SCI.

Therefore, when the request information and the coordination information are indicated by using one format of the 2^{nd} SCI, how to design the 2^{nd} SCI to achieve a smaller number of bits for the 2^{nd} SCI needs to be considered.

With reference to the accompanying drawings, the following describes in detail the information transmission method and apparatus, the terminal, and the storage medium in the embodiments of this application by using some embodiments and application scenarios thereof.

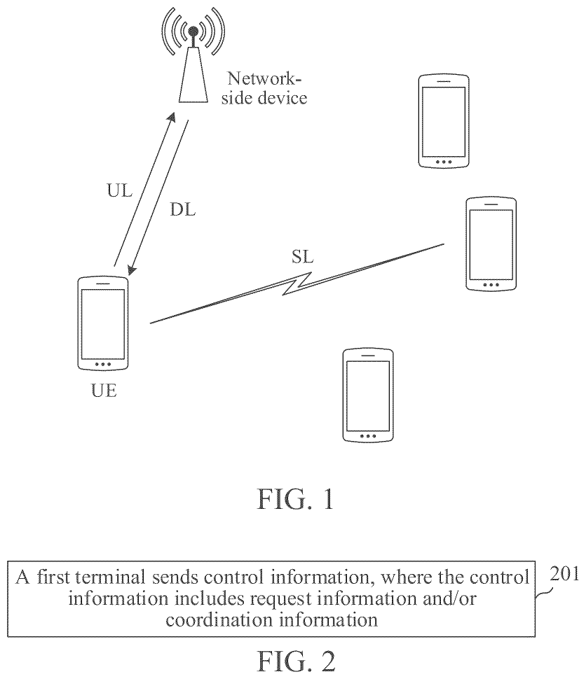

FIG. 2 is a schematic diagram of an information transmission method according to an embodiment of this application. As shown in FIG. 2, this embodiment of this application provides the information transmission method, and the method is performed by a UE, for example, a mobile phone, and includes:

Step 201: A first terminal sends control information.

The control information includes request information and/or coordination information. The control information carries identification information. When the identification information indicates that the control information includes the request information, the terminal obtains the request information from the corresponding indication information. When the identification information indicates that the control information includes the coordination information, the terminal obtains the coordination information from the corresponding indication information,

In some embodiments, the control information includes at least one of the following indication information:
resource selection window indication information;
start time location indication information of a resource selection window;
end time location indication information of the resource selection window;
indication information of a maximum number of reserved periods for resource selection;
indication information of a number of subchannels occupied by sending data;
remaining PDB indication information, indicating a time range in which a terminal that receives the request information or a terminal that is to send the coordination information may select a resource to send the coordination information; or first resource location indication information.

In some embodiments, the resource selection window indication information is determined by using at least one of the following:
a first reference location;
a start time location of the resource selection window;
an end time location of the resource selection window;
a third time unit offset, where the third time unit offset is a time unit offset relative to the start time location of the resource selection window or the first reference location, and it should be noted that the time unit offset in this specification may be logical time or physical time; or
a RIV.

For example, the resource selection window indication information may be determined by using the start time location of the resource selection window and the third time unit offset, by using the end time location of the resource selection window and the third time unit offset, by using the start time location of the resource selection window and the end time location of the resource selection window, by using the first reference location, the start time location of the resource selection window, and the third time unit offset, or by using other information. In addition, an indication method for the indication information includes a DFN, a time unit index, the RIV, and the like. An indication manner of the RIV is indicating a resource indication value, and the resource indication value may be obtained by encoding a plurality of pieces of indication information together according to the idea of joint encoding, for example, one field may indicate a plurality of pieces of information content. For example, the RIV indicates the start time location of the resource selection window and the third time unit offset.

In some embodiments, the start time location and/or the end time location of the resource selection window is indicated by at least one of the following:
a DFN;
a time unit index within a radio frame; or
a fourth time unit offset, where the fourth time unit offset is a time unit offset relative to the first reference location.

For example, when the start time location and/or the end time location of the resource selection window is indicated, a DFN number of the start time location and/or a DFN number of the end time location and the time unit index within the radio frame may be directly indicated. In some alternative embodiments, the start time location of the resource selection window may be indicated by using a DFN number and the time unit index within the radio frame, and the end time location is indicated by using a time unit offset of the end time location relative to the start time location. In another method, only a DFN number is indicated to indicate the start time location of the resource selection window, and the time unit index of the start time location and a time unit offset of the end time location relative to the start time location are both indicated through joint encoding or by using the RIV.

In some embodiments, the first reference location is at least one of the following:
a location whose DFN is 0 and time unit index is 0, where the 1^{st} time unit in the 1^{st} radio frame indicated by a DFN obtained by cycling every 1024 radio frames is used as a reference location, in other words, a time location is directly indicated by a DFN and a time unit index of a radio frame in which the time location is located;
the 1^{st} time unit location of the DEN in which the start time location of the resource selection window is located;
a time location for transmitting the control information, which may also be described as a time location for receiving the control information from the perspective of a receiving end of the control information; or
a location following, by M time units, the time location for transmitting the control information, where M is predefined in a protocol, preconfigured on a network, or configured on the network, which may also be described as a location following, by M time units, the time location for receiving the control information from the perspective of the receiving end of the control information. In this case, it is considered that in a case of synchronization between sending and receiving ends, a fixed location that is for receiving or sending a HARQ feedback and that meets processing time and/or HARQ feedback time after the control information is transmitted may be used as a reference location.

In some embodiments, a resource selection window indicated by the resource selection window indication information meets at least one of the following:
a size that is of the resource selection window and that is predefined in a protocol, preconfigured on the network, or configured on the network is maximally Wₘₐₓ, where in this case, because a maximum value of the resource window is limited, a number of bits that need to be occupied by the resource selection window indication information is also limited, and a part of bit locations can be saved when a control signaling format is designed; or
a size that is of the resource selection window and that is predefined in a protocol, preconfigured on the network, or configured on the network is minimally Wₘᵢₙ, where in this case, because a minimum value of the resource window is limited, a part of the invalid code points can be discarded during the joint encoding, to reduce a number of bits, where

$${W}_{min} \leq L \leq T 1 + {W}_{max} - {T}_{start} ; and$$

$${W}_{min} \leq L \leq T 1 - {T}_{start} ,$$

where

L is a time unit offset, namely, a size that is of the resource selection window and that is indicated in the control information. Wₘᵢₙ is a minimum value of the time unit offset, T1 is an indication range of the 1024 radio frames, and Tₛₜₐᵣₜ is the start time location of the resource selection window.

In some embodiments, the RIV is determined by using at least one of the following:
RIV=S(L−Wₘᵢₙ)+Tₛₜₐᵣₜ, where in this case, it is predefined in a protocol or preconfigured on the network that the size of the resource selection window or the size of the resource selection window minus Wₘᵢₙ is constantly less than S/2, and therefore a case in which the size or the size minus Wₘᵢₙ is greater than S/2 does not need to be considered;
RIV=L, where in this case, the size of the resource selection window is directly indicated by the time unit offset of the end time location relative to the start time location, and the start time location may be indicated by the DFN and the time unit index within the radio frame;

$$RIV = \{ \begin{matrix}S ( L - {W}_{min} ) + {T}_{start} , & ( L - {W}_{min} ) \leq ⌊ S / 2 ⌋ \\ S ( S - L + {W}_{min} ) + ( S - 1 - {T}_{start} ) , & ( L - {W}_{min} ) > ⌊ S / 2 ⌋\end{matrix} ,$$

where in this case, a possibility that the size of the resource selection window minus Wₘᵢₙ is greater than S/2 is considered;

RIV=Wₘₐₓt₃+t₄, where in this case, it is considered to jointly encode a time unit offset of the start time location of the resource selection window relative to a start time unit in a radio frame in which the start time location is located and a time unit offset of the end time location of the resource selection window relative to the start time unit in the radio frame in which the start time location is located;

RIV=Wₘₐₓ(t₄−t₃−1)+t₃, where in this case, it is considered to jointly encode a time unit offset of the start time location of the resource selection window relative to a start time unit in a radio frame in which the start time location is located and a time unit offset of the end time location of the resource selection window relative to the start time unit in the radio frame in which the start time location is located; or

$$RIV = \{ \begin{matrix}( {W}_{max} - 1 ) ( {t}_{2} - {t}_{1} - 1 ) + {t}_{1} + {W}_{max} , & ( {t}_{2} - {t}_{1} - 1 ) < ⌊ {W}_{max} / 2 ⌋ \\ ( {W}_{max} - 1 ) ( {W}_{max} - {t}_{2} + {t}_{1} ) + 2 {W}_{max} - {t}_{1} , & ( {t}_{2} - {t}_{1} - 1 ) \geq ⌊ {W}_{max} / 2 ⌋\end{matrix} ,$$

where in this case, both the start time location and the end time location of the resource selection window are determined by using time unit offsets relative to the reference location.

S=T1+Wₘₐₓ, T1 is the indication range of the 1024 radio frames, Wₘₐₓ is a maximum value of a size of the resource selection window, L is the time unit offset, Tₛₜₐᵣₜ is the start time location of the resource selection window, Wₘᵢₙ is a minimum value of the size of the resource selection window, t₃ is a time unit offset of the start time location of the resource selection window relative to the first reference location, and t₄ is a time unit offset of the end time location of the resource selection window relative to the first reference location.

For example, when the start/end time location of the resource selection window is indicated, a most direct method is to indicate both the DFN number and the slot index within the radio frame that are of the start/end time location. In this case, the first reference location is a DFN 0 or a slot index 0. However, this method requires a large number of bits, and is not well suitable for SCI signaling with a limited number of bits.

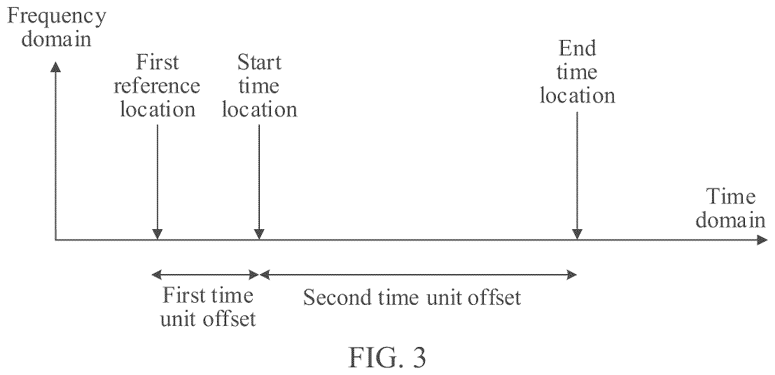

Therefore, it is first considered to limit the size of the resource selection window. FIG. 3 is a schematic diagram of an indication principle for a resource selection window according to an embodiment of this application. As shown in FIG. 3, an end time location of a resource selection window may be indicated by an offset of the end time location relative to a start time location instead of a DFN number and a slot index. For example, if it is predefined in a protocol, preconfigured on a network, or configured on the network that a size of the resource selection window is maximally 256 slots, a maximum number of bits of a second time unit offset (slot_offset2) needs to be only 8, which is much less than a minimum number of bits, namely, 14, in a method using the DFN number and the slot index. In addition, the start time location of the resource selection window and the time domain offset of the end time location relative to the start time location may be jointly encoded according to the idea of joint encoding. For example, in the foregoing case, L represents the size of the resource selection window, namely, the slot_offset2, and S represents a maximum value of a sum of the size of the resource selection window and a maximum indication range in the DFN indication method. In this case, the start time location of the resource selection window and the time domain offset of the end time location relative to the start time location may be indicated by an RIV according to the idea of joint encoding, where a rule may be RIV=S(L−Wₘᵢₙ)+Tₛₜₐᵣₜ. In this case, Tₛₜₐᵣₜ is the start time location of the resource selection window.

Further, it is considered that a number of bits is always designed to indicate a maximum range. This results in some invalid code points in the slot index indication, and may also result in some invalid code points in the slot_offset2. Therefore, the slot index and the slot_offset2 may be considered to be jointly encoded to reduce the number of bits. For example, in this case, the reference slot location is still the DFN 0 or the slot index 0, but a method for indicating the start time location of the resource selection window is to indicate, by using a DFN number, a number of the radio frame in which the start time location is located, and the slot location, namely, the slot index, is jointly encoded with the slot_offset2 indicating the end time location. An encoding rule may be RIV=Wₘₐₓt₁+t₂ or RIV=Wₘₐₓ(t2−t1−1)+t1. Wₘₐₓ is the maximum value that is of the size of the resource selection window and that is predefined in the protocol, preconfigured on the network, or configured on the network, t1 is a value of the slot index, and t₂ is a value of the slot_offset2.

Still further, when the reference slot indication is an absolute time domain location in which both the receiving and sending ends are aligned, and is not the DFN 0 or the slot index 0, the start time location of the resource selection window may also be represented by a time domain offset, for example, a slot_offset1 shown in the figure. In this case, the number of bits can be reduced by using the joint encoding scheme, and can be further compressed when the maximum value of the size of the resource selection window is predefined in the protocol, preconfigured on the network, or configured on the network. For example, in this case, it is assumed that t₁ is the time domain offset, namely, the slot_offset1, of the start time location of the resource selection window relative to the reference slot indication, and t₂ is the time domain offset, namely, the slot_offset2, of the end time location of the resource selection window relative to the reference slot indication. The encoding rule may be as follows:

$$RIV = \{ \begin{matrix}( {W}_{max} - 1 ) ( {t}_{2} - {t}_{1} - 1 ) + {t}_{1} + {W}_{max} , & ( {t}_{2} - {t}_{1} - 1 ) < ⌊ {W}_{max} / 2 ⌋ \\ ( {W}_{max} - 1 ) ( {W}_{max} - {t}_{2} + {t}_{1} ) + 2 {W}_{max} - {t}_{1} , & ( {t}_{2} - {t}_{1} - 1 ) \geq ⌊ {W}_{max} / 2 ⌋\end{matrix}$$

In some embodiments, the first resource location indication information indicates first resource locations of N TRIVs, where N is a positive integer. The first resource location is a reference location of a resource indication carried in the TRIV. In principle, information indicated in the TRIV is a time unit offset relative to the reference location. Therefore, if the first resource location of each TRIV is not indicated in the control information, resources indicated by the resource indication carried in the TRIV cannot be obtained through decoding.

In some embodiments, the first resource location indication information meets at least one of the following:
a number that is of bits of the first resource location indication information and that is predefined in a protocol is L_{bit};
in the first resource location indication information, a number of bits indicating a first resource location of the 1^{st} TRIV is L1, a number of bits indicating a first resource location of the 2^{nd} TRIV is L2, and a number of bits indicating a first resource location of the 3^{rd} TRIV is L3, where L1+L2+L3=L_{bit}, and in this case, as a maximum number of bits occupied by the first resource location in each TRIV is predefined in a protocol, an indication range of a first resource in each TRIV is determined;
the first resource location of the 1^{st} TRIV is indicated by a time unit offset relative to a second reference location, and a first resource location of a TRIV other than the 1^{st} TRIV is indicated by a time unit offset to a last actual indicated time unit in an immediate previous TRIV;
the N first resource locations are indicated by time unit offsets relative to the second reference location, where in this case, the first resource location of each TRIV is determined by using the second reference location and the time unit offset relative to the second reference location;
the first resource location of the 1^{st} TRIV is indicated based on the second reference location and/or a first time unit offset;
the first resource location of the 2^{nd} TRIV is indicated based on the second reference location and/or a second time unit offset; or
it is predefined in a protocol, preconfigured on the network, or configured on the network that the first resource location of the 1^{st} TRIV is an x^{th} time unit after the second reference location, where
L_{bit}, L1, L2, L3, N, and x are all positive integers.

In some embodiments, the first time unit offset is predefined in a protocol, preconfigured on the network, or configured on the network.

The second time unit offset is predefined in a protocol, preconfigured on the network, or configured on the network.

In some embodiments, a maximum value of the first time unit offset is predefined in a protocol, preconfigured on the network, or configured on the network; or
a maximum value of the second time unit offset is predefined in a protocol, preconfigured on the network, or configured on the network.

In some embodiments, an index indication range of the first time unit offset includes all or a part of time unit locations within all or a part of DFNs; or
an index indication range of the second time unit offset includes all or a part of time unit locations within all or a part of DFNs.

In some embodiments, an index indication range of the second reference location includes all time unit locations within all DFNs.

For example, the index indication range of the second reference location includes all the time unit locations within all the DFNs, in other words, a configuration range of the second reference location is a maximum indication range of the DFN.

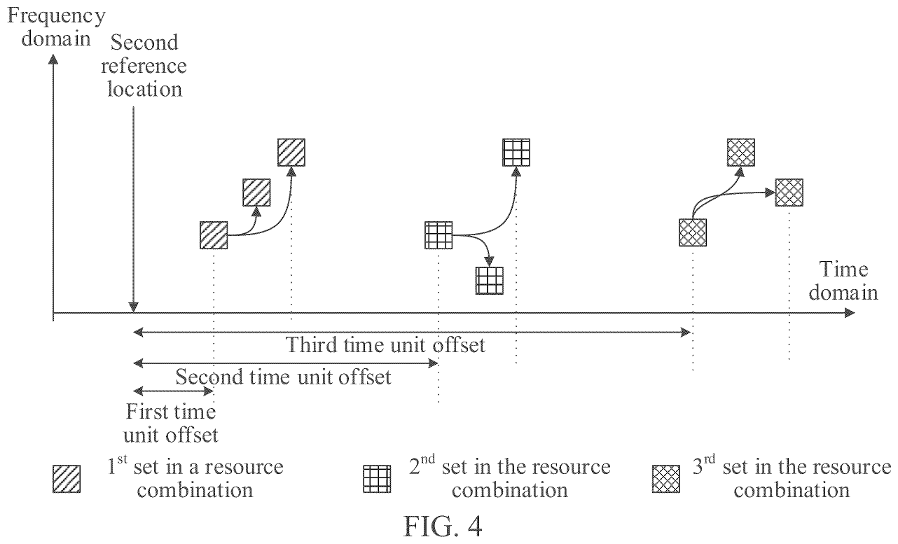

For example, FIG. 4 is a schematic diagram 1 of an indication principle for a first resource location according to an embodiment of this application. As shown in FIG. 4, first resource locations in three TRIVs may be separately indicated by time slot offsets relative to a second reference location M. In this case, a maximum number of resources indicated in the coordination information carried in 2^{nd} SCI may be 9. In this case, because a slot offset range needs to be indicated by a large number of bits when a limit case is considered, the number of bits can be reduced according to the idea of joint encoding.

For example, a first time unit offset (slot_offset1), a second time unit offset (slot_offset2), and a third time unit offset (slot_offset3) may be jointly encoded, the slot_offset1 and the slot_offset2 may be jointly encoded, or the slot_offset2 and the slot_offset3 may be jointly encoded.

Because the slot_offset1 is constantly less than the slot_offset2, the slot_offset1 may be denoted as t₁, and the slot_offset2 may be denoted as t₂. In addition, if a maximum slot offset range is K, the slot_offset1 and the slot_offset2 indicated in the TRIV may be calculated according to a first rule.

In this case, if a maximum value of the number of bits of the first resource location is predefined in a protocol, nine resources within different ranges instead of six resources in a solution to indicating the first resource location through preconfiguration may still be indicated according to different numbers of bits. This can maximally utilize transmission of the coordination information.

In some embodiments, the first resource location indication information meets at least one of the following:
N is equal to 2 or 3; or
the first resource location is indicated by a time unit offset relative to a second reference location.

In some embodiments, the second reference location is at least one of the following:
a location whose DFN is 0 and time unit index is 0;
the 1^{st} time unit location of a DEN in which the start time location of the resource selection window is located;
the start time location of the resource selection window;
a last actual indicated time unit in the 1^{st} TRIV;
a time location for transmitting the control information, which may also be described as a time location for receiving the control information from the perspective of a receiving end of the control information;
a location following, by M time units, the time location for transmitting the control information, where M is predefined in a protocol, preconfigured on the network, or configured on the network, which may also be described as a location following, by M time units, the time location for receiving the control information from the perspective of the receiving end of the control information, where in this case, it is considered that in a case of synchronization between sending and receiving ends, a fixed location that is for receiving or sending a HARQ feedback and that meets processing time and/or HARQ feedback time after the control information is transmitted may be used as a reference location;
a start location of a resource selection period;
a last actual indicated time unit in an immediate previous TRIV; or
a first resource location of the immediate previous TRIV.

In some embodiments, a maximum value of the second reference location is predefined in the protocol, preconfigured on the network, or configured on the network.

In some embodiments, in a case that first resource locations of the first two TRIVs are indicated in a RIV form, a first resource location of the 3^{rd} TRIV is indicated by a time unit offset relative to a last actual indicated time unit in an immediate previous TRIV; or

in a case that first resource locations of last two TRIVs are indicated in a RIV form, a first resource location of the 1^{st} TRIV is indicated by a time unit offset relative to the second reference location.

For example, in this embodiment of this application, the first resource location indication information may indicate the first resource locations of the first two TRIVs in the RIV form, for example, may indicate the first resource locations of the first two TRIVs in the RIV form. In this case, the first resource location of the 3^{rd} TRIV is indicated by the time unit offset relative to the last actual indicated time unit in the 2^{nd} TRIV.

The first resource location indication information may indicate the first resource locations of the last two TRIVs in the RIV form, for example, may indicate the first resource locations of the last two TRIVs in the RIV form. In this case, the first resource location of the 1^{st} TRIV is indicated by the time unit offset relative to the second reference location.

In some embodiments,

$$RIV = \{ \begin{matrix}( K - 1 ) ( {t}_{2} - {t}_{1} - 1 ) + {t}_{1} + K , & {t}_{2} - {t}_{1} - 1 \leq ⌊ K / 2 ⌋ \\ ( K - 1 ) ( K - {t}_{2} + {t}_{1} ) + 2 ( K ) - {t}_{1} , & {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on the network, or configured on the network;
a time unit offset of the end time location of the resource selection window relative to the second reference location; or
a time unit offset of the end time location of the resource selection window relative to the second reference location minus processing time.

In some embodiments, in a case that N is equal to 2,

$$RIV = \{ \begin{matrix}( K - 1 ) ( {t}_{2} - {t}_{1} - 1 ) + {t}_{1} + K & , {t}_{2} - {t}_{1} - 1 \leq ⌊ K / 2 ⌋ \\ ( K - 1 ) ( K - {t}_{2} + {t}_{1} ) + 2 ( K ) - {t}_{1} & , {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on the network, or configured on the network;
a time unit offset of the end time location of the resource selection window relative to the second reference location; or
a time unit offset of the end time location of the resource selection window relative to the second reference location minus processing time.

In some embodiments, the first resource location indication information indicates first resource locations of two TRIVs in a RIV form.

In some embodiments, the first resource location indication information meets at least one of the following:
a first resource location of the 1^{st} TRIV is indicated by a time unit offset relative to the second reference location;
a first resource location of the 2^{nd} TRIV is indicated by a time unit offset relative to a last actual indicated time unit in the 1^{st} TRIV;
a first resource location of the 3^{rd} TRIV is indicated by a time unit offset relative to a last actual indicated time unit in the 2^{nd} TRIV;
first resource locations of two TRIVs are indicated by time unit offsets relative to the second reference location; or
t₁<t₂≤X, where X=2^{(B+1)/2}, t₁ is the time unit offset of the first resource location of the 1^{st} TRIV relative to the second reference location, t₂ is a time unit offset of the first resource location of the 2^{nd} TRIV relative to the second reference location or the time unit offset of the first resource location of the 2^{nd} TRIV relative to the last actual indicated time unit in the 1^{st} TRIV, or is a time unit offset of the first resource location of the 3^{rd} TRIV relative to the second reference location or the time unit offset of the first resource location of the 3^{rd} TRIV relative to the last actual indicated time unit in the second TRIV, and B is a number that is of bits of a TRIV and that is preconfigured or configured on the network.

In some embodiments,

$$RIV = \{ \begin{matrix}( X - 1 ) ( {t}_{2} - {t}_{1} - 1 ) + {t}_{1} + X & , {t}_{2} - {t}_{1} - 1 \leq ⌊ X / 2 ⌋ \\ ( X - 1 ) ( X - {t}_{2} + {t}_{1} ) + 2 ( X ) - {t}_{1} & , {t}_{2} - {t}_{1} - 1 > ⌊ X / 2 ⌋\end{matrix}$$

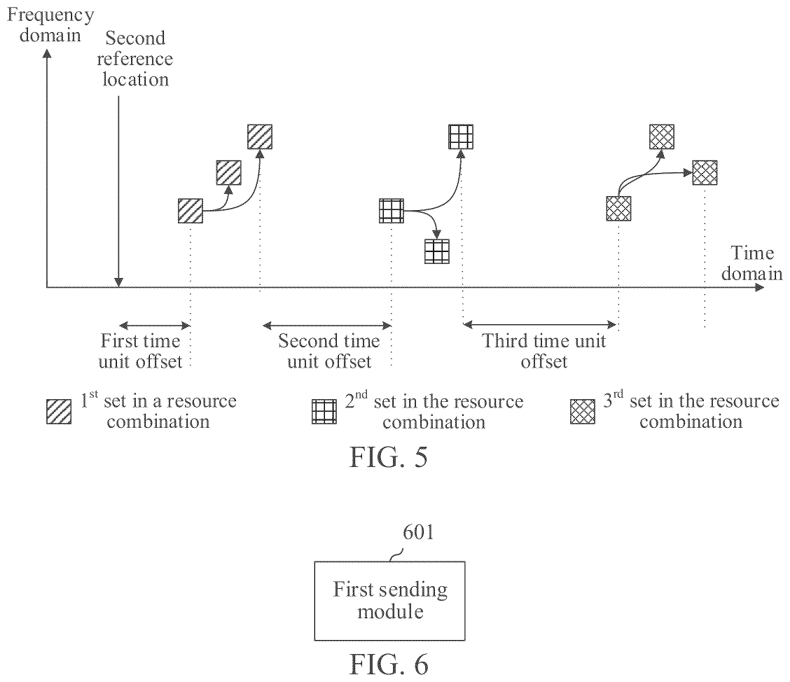

For example, FIG. 5 is a schematic diagram 2 of an indication principle for a first resource location according to an embodiment of this application. As shown in FIG. 5, an indication of a first resource location of the 1^{st} TRIV is still defined as a slot offset relative to a second reference location M, and a first resource location of a subsequent TRIV is indicated by a slot offset relative to a last actual indicated slot in an immediate previous TRIV.

In this case, an indication by the TRIV may also be designed according to the idea in the foregoing embodiment with allowance of a number of bits, and any one of a case of the slot_offset1 and the slot_offset2, a case of the slot_offset2 and the slot_offset3, or a case of the slot_offset1 and the slot_offset3 may be indicated through predefinition in a protocol, preconfiguration on the network, configuration on the network, or the like.

In addition to this, this solution is suitable for a case in which a number of bits in the first resource location indication information is limited. Assuming that it is predefined in a protocol that the number of bits of the indication information is maximally 19, 10 of the 19 bits may indicate a location of one of the three slot_offsets, so that a resource range that can be indicated in the solution is not limited to a very small range. By using the remaining 9 bits, one slot_offset may be selected within 0 to 30 slots in the joint encoding scheme with a second rule, and the other slot_offset is selected within 0 to 31 slots (in which case a previous slot_offset must be smaller than a subsequent slot_offset). In this case, there is sufficient flexibility for the UE to select a first resource that can be used as a recommended/non-recommended resource. If the joint encoding scheme is not applied, according to a rule of pre-allocating the number of bits, a slot resource within a range may be indicated as a first resource without a size limitation between slot_offsets.

In some embodiments, in a case that a first identifier in the control information indicates that the control information includes the coordination information, A^{th} to C^{th} bits in the control information are resource combination indication information; or when a first identifier in the control information indicates that the control information includes the request information, A^{th} to C^{th} bits in the control information include at least one of the following indication information:
start time location indication information of a resource selection window;
end time location indication information of the resource selection window;
indication information of a maximum number of reserved periods for resource selection;
indication information of a number of subchannels occupied by sending data; or
remaining PDB indication information.

In this case, a location of a bit of a field in which a part of indication information is located when the request information is transmitted by using the control signaling is designed to be placed in a location of a field occupying a large number of bits when the coordination information is transmitted by using the control signaling. This can reduce a number of bits needed for the control signaling and does not affect information indication.

It is assumed that when a flag indicates that SCI format 2-C is currently coordination information signaling, bit locations of indication information of Resource combination(s) in the SCI format 2-C are A^{th} to C^{th} bits. In this case, when the flag indicates that the SCI format 2-C carries the request information, the locations of the A^{th} to C^{th} bits include at least one of the following indication information:
i. the start time location indication information of the resource selection window (starting time position of resource selection window), where the indication information may indicate the start time location of the resource selection window for the coordination information or the resource selection window for sending the coordination information; and the end time location indication information of the resource selection window (ending time position of resource selection window), where the indication information may indicate the end time location of the resource selection window for the coordination information or the resource selection window for sending the coordination information;
ii. C_resel indication information, where the indication information may indicate a maximum number of reserved periods for resource selection by a terminal that receives the coordination information;
iii. Number of subchannels indication information, where the indication information may indicate a number of subchannels occupied by the terminal that receives the coordination information to send data; or
iv. Remaining PDB indication information, where the indication information may indicate a latest time domain location in which the terminal that receives the coordination information expects to receive the coordination information.

According to the information transmission method provided in this embodiment of this application, the first terminal sends the control information to a second terminal, where the control information includes the request information and/or the coordination information. In this way, the request information and the coordination information are transmitted by occupying a small number of bits of the control information.

The information transmission method provided in the embodiments of this application may be performed by an information transmission apparatus. In the embodiments of this application, an example in which the information transmission apparatus performs the information transmission method is used to describe the information transmission apparatus provided in the embodiments of this application.

FIG. 6 is a schematic diagram of an information transmission apparatus according to an embodiment of this application. As shown in FIG. 6, the information transmission apparatus provided in this embodiment of this application includes:
a first sending module, used by a first terminal to send control information, where
the control information includes request information and/or coordination information.

In some embodiments, the control information includes at least one of the following indication information:
resource selection window indication information;
start time location indication information of a resource selection window;
end time location indication information of the resource selection window;
indication information of a maximum number of reserved periods for resource selection;
indication information of a number of subchannels occupied by sending data;
remaining PDB indication information; or
first resource location indication information.

In some embodiments, the resource selection window indication information is determined by using at least one of the following:
a first reference location;
a start time location of the resource selection window;
an end time location of the resource selection window;
a third time unit offset, where the third time unit offset is a time unit offset relative to the start time location of the resource selection window or the first reference location; or
a RIV.

In some embodiments, the start time location and/or the end time location of the resource selection window is indicated by at least one of the following:
a DFN;
the DFN plus a time unit index within a radio frame; or
a fourth time unit offset, where the fourth time unit offset is a time unit offset relative to the first reference location.

In some embodiments, the first reference location is at least one of the following:
a location whose DFN is 0 and time unit index is 0;
the 1^{st} time unit location of a DFN in which the start time location of the resource selection window is located;
a time location for transmitting the control information; or
a location following, by M time units, the time location for transmitting the control information, where M is predefined in a protocol, preconfigured on a network, or configured on the network.

In some embodiments, a resource selection window indicated by the resource selection window indication information meets at least one of the following:
a size that is of the resource selection window and that is predefined in a protocol, preconfigured on a network, or configured on the network is maximally Wₘₐₓ; or
a size that is of the resource selection window and that is predefined in a protocol, preconfigured on a network, or configured on the network is minimally Wₘᵢₙ, where

$${W}_{min} \leq L \leq T 1 + {W}_{max} - {T}_{start} ;$$

$$and$$

$${W}_{min} \leq L \leq T 1 - {T}_{start} ,$$

where

L is a time unit offset, Wₘᵢₙ is a minimum value of the time unit offset, T1 is an indication range of 1024 radio frames, and Tₛₜₐᵣₜ is a start time location of the resource selection window.

In some embodiments, the RIV is determined by using at least one of the following:

$$RIV = S ( L - {W}_{min} ) + {T}_{start} ;$$

$$RIV = L ;$$

$$RIV = \{ \begin{matrix}S ( L - {W}_{min} ) + {T}_{start} & , ( L - {W}_{min} ) \leq ⌊ S / 2 ⌋ \\ S ( S - L + {W}_{min} ) + ( S - 1 - {T}_{start} ) & , ( L - {W}_{min} ) > ⌊ S / 2 ⌋\end{matrix} ;$$

$$RIV = {W}_{max} {t}_{3} + {t}_{4} ;$$

$$RIV = {W}_{max} ( {t}_{4} - {t}_{3} - 1 ) + {t}_{3} ;$$

$$or$$

$$RIV = \{ \begin{matrix}( {W}_{max} - 1 ) ( {t}_{2} - {t}_{1} - 1 ) + {t}_{1} + {W}_{max} & , ( {t}_{2} - {t}_{1} - 1 ) < ⌊ {W}_{max} / 2 ⌋ \\ ( {W}_{max} - 1 ) ( {W}_{max} - {t}_{2} + {t}_{1} ) + 2 {W}_{max} - {t}_{1} & , ( {t}_{2} - {t}_{1} - 1 ) \geq ⌊ {W}_{max} / 2 ⌋\end{matrix} ,$$

where

S=T1+Wₘₐₓ, T1 is an indication range of 1024 radio frames, Wₘₐₓ is a maximum value of a size of the resource selection window, L is a time unit offset, Tₛₜₐᵣₜ is the start time location of the resource selection window, Wₘᵢₙ is a minimum value of the size of the resource selection window, t₃ is a time unit offset of the start time location of the resource selection window relative to the first reference location, and t₄ is a time unit offset of the end time location of the resource selection window relative to the first reference location.

In some embodiments, the first resource location indication information indicates first resource locations of N TRIVs, where N is a positive integer.

In some embodiments, the first resource location indication information meets at least one of the following:
a number that is of bits of the first resource location indication information and that is predefined in a protocol is L_{bit};
in the first resource location indication information, a number of bits indicating a first resource location of the 1^{st} TRIV is L1, a number of bits indicating a first resource location of the 2^{nd} TRIV is L2, and a number of bits indicating a first resource location of the 3^{rd} TRIV is L3, where L1+L2+L3=L_{bit};
the first resource location of the 1^{st} TRIV is indicated by a time unit offset relative to a second reference location, and a first resource location of a TRIV other than the 1^{st} TRIV is indicated by a time unit offset to a last actual indicated time unit in an immediate previous TRIV;
the N first resource locations are indicated by time unit offsets relative to the second reference location;
the first resource location of the 1^{st} TRIV is indicated based on the second reference location and/or a first time unit offset;
the first resource location of the 2^{nd} TRIV is indicated based on the second reference location and/or a second time unit offset; or
it is predefined in a protocol, preconfigured on a network, or configured on the network that the first resource location of the 1^{st} TRIV is an x^{th} time unit after the second reference location, where
L_{bit}, L1, L2, L3, N, and x are all positive integers.

In some embodiments, the first time unit offset is predefined in a protocol, preconfigured on the network, or configured on the network; and
the second time unit offset is predefined in a protocol, preconfigured on the network, or configured on the network.

In some embodiments, a maximum value of the first time unit offset is predefined in a protocol, preconfigured on the network, or configured on the network; or
a maximum value of the second time unit offset is predefined in a protocol, preconfigured on the network, or configured on the network.

In some embodiments, an index indication range of the first time unit offset includes all or a part of time unit locations within all or a part of DFNs; or
an index indication range of the second time unit offset includes all or a part of time unit locations within all or a part of DFNs.

In some embodiments, an index indication range of the second reference location includes all time unit locations within all DFNs.

In some embodiments, the first resource location indication information meets at least one of the following:
N is equal to 2 or 3; or
the first resource location is indicated by a time unit offset relative to the second reference location.

In some embodiments, the second reference location is at least one of the following:
a location whose DFN is 0 and time unit index is 0;
the 1^{st} time unit location of a DFN in which the start time location of the resource selection window is located;
the start time location of the resource selection window;
a last actual indicated time unit in the 1^{st} TRIV;
a time location for transmitting the control information,
a location following, by M time units, the time location for transmitting the control information, where M is predefined in a protocol, preconfigured on a network, or configured on the network;
a start location of a resource selection period;
a last actual indicated time unit in an immediate previous TRIV; or
a first resource location of the immediate previous TRIV.

In some embodiments, a maximum value of the second reference location is predefined in a protocol, preconfigured on the network, or configured on the network.

In some embodiments, in a case that first resource locations of the first two TRIVs are indicated in a RIV form, a first resource location of the 3^{rd} TRIV is indicated by a time unit offset relative to a last actual indicated time unit in an immediate previous TRIV; or

in a case that first resource locations of last two TRIVs are indicated in a RIV form, a first resource location of the 1^{st} TRIV is indicated by a time unit offset relative to the second reference location.

In some embodiments,

$$RIV = \{ \begin{matrix}( K - 1 ) ( {t}_{2} - {t}_{1} - 1 ) + {t}_{1} + K & , {t}_{2} - {t}_{1} - 1 \leq ⌊ K / 2 ⌋ \\ ( K - 1 ) ( K - {t}_{2} + {t}_{1} ) + 2 ( K ) - {t}_{1} & , {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on a network, or configured on the network;
a time unit offset of an end time location of the resource selection window relative to the second reference location; or
the time unit offset of the end time location of the resource selection window relative to the second reference location minus processing time.

In some embodiments, in a case that N is equal to 2,

$$RIV = \{ \begin{matrix}( K - 1 ) ( {t}_{2} - {t}_{1} - 1 ) + {t}_{1} + K & , {t}_{2} - {t}_{1} - 1 \leq ⌊ K / 2 ⌋ \\ ( K - 1 ) ( K - {t}_{2} + {t}_{1} ) + 2 ( K ) - {t}_{1} & , {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on a network, or configured on the network;
a time unit offset of an end time location of the resource selection window relative to the second reference location; or
the time unit offset of the end time location of the resource selection window relative to the second reference location minus processing time.

In some embodiments, the first resource location indication information indicates first resource locations of two TRIVs in a RIV form.

In some embodiments, the first resource location indication information meets at least one of the following:
a first resource location of the 1^{st} TRIV is indicated by a time unit offset relative to a second reference location;
a first resource location of the 2^{nd} TRIV is indicated by a time unit offset relative to a last actual indicated time unit in the 1^{st} TRIV;
a first resource location of the 3^{rd} TRIV is indicated by a time unit offset relative to a last actual indicated time unit in the 2^{nd} TRIV;
first resource locations of two TRIVs are indicated by time unit offsets relative to the second reference location; or
t₁<t₂≤X, where X=2^{(B+1)/2}, t₁ is the time unit offset of the first resource location of the 1^{st} TRIV relative to the second reference location, t₂ is a time unit offset of the first resource location of the 2^{nd} TRIV relative to the second reference location or the time unit offset of the first resource location of the 2^{nd} TRIV relative to the last actual indicated time unit in the 1^{st} TRIV, or is a time unit offset of the first resource location of the 3^{rd} TRIV relative to the second reference location or the time unit offset of the first resource location of the 3^{rd} TRIV relative to the last actual indicated time unit in the second TRIV, and B is a number that is of bits of a TRIV and that is preconfigured or configured on a network.

In some embodiments,

$$RIV = \{ \begin{matrix}( X - 1 ) ( {t}_{2} - {t}_{1} - 1 ) + {t}_{1} + X & , {t}_{2} - {t}_{1} - 1 \leq ⌊ X / 2 ⌋ \\ ( X - 1 ) ( X - {t}_{2} + {t}_{1} ) + 2 ( X ) - {t}_{1} & , {t}_{2} - {t}_{1} - 1 > ⌊ X / 2 ⌋\end{matrix}$$

In some embodiments, in a case that a first identifier in the control information indicates that the control information includes the coordination information, A^{th} to C^{th} bits in the control information are resource combination indication information; or when a first identifier in the control information indicates that the control information includes the request information, A^{th} to C^{th} bits in the control information include at least one of the following indication information:
start time location indication information of a resource selection window;
end time location indication information of the resource selection window;
indication information of a maximum number of reserved periods for resource selection;
indication information of a number of subchannels occupied by sending data; or
remaining PDB indication information.

According to the information transmission apparatus, provided in this embodiment of this application, the first terminal sends the control information to a second terminal, where the control information includes the request information and/or the coordination information. In this way, the request information and the coordination information are transmitted by occupying a small number of bits of the control information.

The information transmission apparatus in the embodiments of this application may be an electronic device, or may be a component, for example, an integrated circuit or a chip, in the electronic device. The electronic device may be a terminal or a device other than the terminal. For example, the electronic device may be a mobile phone, a tablet computer, a notebook computer, a palmtop computer, a vehicle-mounted electronic device, an MID, an AR/VR device, a robot, a wearable device, an UMPC, a netbook, or a PDA; or may be a server, a Network Attached Storage (NAS, a PC, a Television (TV), a teller machine, or an automated machine. This is not specifically limited in the embodiments of this application.

The information transmission apparatus in the embodiments of this application may be an apparatus with an operating system. The operating system may be an Android operating system, may be an iOS operating system, or may be another possible operating system. This is not specifically limited in the embodiments of this application.

The information transmission apparatus provided in the embodiments of this application can implement the processes implemented in the foregoing method embodiments and achieve the same technical effects. To avoid repetition, details are not described herein again.

An embodiment of this application further provides a terminal, including a processor and a communication interface. The terminal embodiment corresponds to the foregoing terminal-side method embodiment, and the implementation processes and implementation methods of the foregoing method embodiment can be applied to the terminal embodiment, and the same technical effects can be achieved.

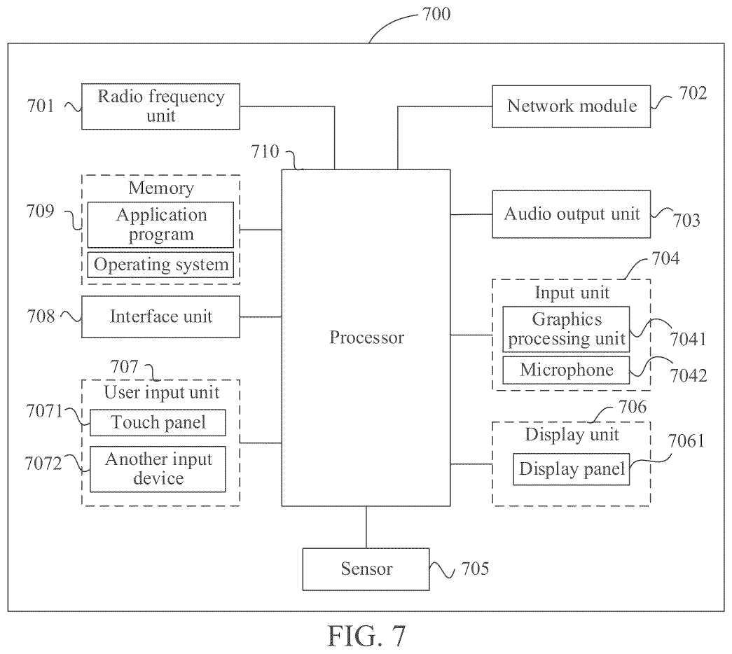

For example, FIG. 7 is a schematic structural diagram of a terminal according to an embodiment of this application. As shown in FIG. 7, the terminal 700 includes but is not limited to: at least a part of a radio frequency unit 701, a network module 702, an audio output unit 703, an input unit 704, a sensor 705, a display unit 706, a user input unit 707, an interface unit 708, a memory 709, a processor 710, and the like.

A person skilled in the art may understand that the terminal 700 may further include a power supply (such as a battery) for supplying power to the components. The power supply may be logically connected to the processor 710 through a power management system, thereby implementing functions such as charging, discharging, and power consumption management through the power management system. The terminal structure shown in FIG. 7 does not constitute a limitation on the terminal, and the terminal may include more or fewer components than those shown in the figure, combine some components, or have different component arrangement. Details are not described herein.

It should be understood that in this embodiment of this application, the input unit 704 may include a Graphics Processing Unit (GPU) 7041 and a microphone 7042, and the graphics processing unit 7041 processes a static picture or video image data obtained by an image capturing apparatus (such as a camera) in a video capturing mode or an image capturing mode. The display unit 706 may include a display panel 7061, and the display panel 7061 may be configured by using a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to, a physical keyboard, a function key (such as a volume control key or a switch key), a track ball, a mouse, and a joystick. Details are not described herein.

In this embodiment of this application, after receiving downlink data from a network-side device, the radio frequency unit 701 may transmit the downlink data to the processor 710 for processing. In addition, the radio frequency unit 701 may send uplink data to the network-side device. Generally, the radio frequency unit 701 includes but is not limited to an antenna, an amplifier, a transceiver, a coupler, a low noise amplifier, a duplexer, and the like.

The memory 709 may be configured to store a software program, instructions, and various data. The memory 709 may mainly include a first storage area that stores a program or instructions and a second storage area that stores data. The first storage area may store an application program or instructions required by an operating system or at least one function (for example, a sound playback function and an image playback function), and the like. In addition, the memory 709 may include a volatile memory or a nonvolatile memory, or may include both the volatile memory and the nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DR RAM). The memory 709 in this embodiment of this application includes but is not limited to these memories and any other suitable types of memories.

The processor 710 may include one or more processing units. In some embodiments, the processor 710 integrates an application processor and a modem processor, where the application processor mainly processes operations relating to an operating system, a user interface, an application program, and the like. The modem processor mainly processes a wireless communication signal, and for example, is a baseband processor. It may be understood that the foregoing modem processor may not be integrated into the processor 710.

The radio frequency unit 701 is configured to send control information.

The control information includes request information and/or coordination information.

In some embodiments, the control information includes at least one of the following indication information:
resource selection window indication information;
start time location indication information of a resource selection window;
end time location indication information of the resource selection window;
indication information of a maximum number of reserved periods for resource selection;
indication information of a number of subchannels occupied by sending data;
remaining PDB indication information; or
first resource location indication information.

In some embodiments, the resource selection window indication information is determined by using at least one of the following:
a first reference location;
a start time location of the resource selection window;
an end time location of the resource selection window;
a third time unit offset, where the third time unit offset is a time unit offset relative to the start time location of the resource selection window or the first reference location; or
a RIV.

In some embodiments, the start time location and/or the end time location of the resource selection window is indicated by at least one of the following:
a DFN;
the DFN plus a time unit index within a radio frame; or
a fourth time unit offset, where the fourth time unit offset is a time unit offset relative to the first reference location.

In some embodiments, the first reference location is at least one of the following:
a location whose DFN is 0 and time unit index is 0;
the 1^{st} time unit location of a DEN in which the start time location of the resource selection window is located;
a time location for transmitting the control information; or
a location following, by M time units, the time location for transmitting the control information, where M is predefined in a protocol, preconfigured on a network, or configured on the network.

In some embodiments, a resource selection window indicated by the resource selection window indication information meets at least one of the following:
a size that is of the resource selection window and that is predefined in a protocol, preconfigured on a network, or configured on the network is maximally Wₘₐₓ; or
a size that is of the resource selection window and that is predefined in a protocol, preconfigured on a network, or configured on the network is minimally Wₘᵢₙ, where

$${W}_{min} \leq L \leq T 1 + {W}_{max} - {T}_{start} ;$$

$$and$$

$${W}_{min} \leq L \leq T 1 - {T}_{start} ,$$

where

L is a time unit offset, Wₘᵢₙ is a minimum value of the time unit offset, T1 is an indication range of 1024 radio frames, Tₛₜₐᵣₜ is a start time location of the resource selection window.

In some embodiments, the RIV is determined by using at least one of the following:

$$RIV = S ( L - {W}_{min} ) + {T}_{start} ;$$

$$RIV = L ;$$

$$RIV = \{ \begin{matrix}S ( L - {W}_{min} ) + {T}_{start} & , ( L - {W}_{min} ) \leq ⌊ S / 2 ⌋ \\ S ( S - L + {W}_{min} ) + ( S - 1 - {T}_{start} ) & , ( L - {W}_{min} ) > ⌊ S / 2 ⌋\end{matrix} ;$$

$$RIV = {W}_{max} {t}_{3} + {t}_{4} ;$$

$$RIV = {W}_{max} ( {t}_{4} - {t}_{3} - 1 ) + {t}_{3} ;$$

$$or$$

$$RIV = \{ \begin{matrix}( {W}_{max} - 1 ) ( {t}_{2} - {t}_{1} - 1 ) + {t}_{1} + {W}_{max} & , ( {t}_{2} - {t}_{1} - 1 ) < ⌊ {W}_{max} / 2 ⌋ \\ ( {W}_{max} - 1 ) ( {W}_{max} - {t}_{2} + {t}_{1} ) + 2 {W}_{max} - {t}_{1} & , ( {t}_{2} - {t}_{1} - 1 ) \geq ⌊ {W}_{max} / 2 ⌋\end{matrix} ,$$

where
S=T1+Wₘₐₓ, T1 is an indication range of 1024 radio frames, Wₘₐₓ is a maximum value of a size of the resource selection window, L is a time unit offset, Tₛₜₐᵣₜ is the start time location of the resource selection window, Wₘᵢₙ is a minimum value of the size of the resource selection window, t₃ is a time unit offset of the start time location of the resource selection window relative to the first reference location, and t₄ is a time unit offset of the end time location of the resource selection window relative to the first reference location.

In some embodiments, the first resource location indication information indicates first resource locations of N TRIVs, where N is a positive integer.

In some embodiments, the first resource location indication information meets at least one of the following:
a number that is of bits of the first resource location indication information and that is predefined in a protocol is L_{bit};
in the first resource location indication information, a number of bits indicating a first resource location of the 1^{st} TRIV is L1, a number of bits indicating a first resource location of the 2^{nd} TRIV is L2, and a number of bits indicating a first resource location of the 3^{rd} TRIV is L3, where L1+L2+L3=L_{bit};
the first resource location of the 1^{st} TRIV is indicated by a time unit offset relative to a second reference location, and a first resource location of a TRIV other than the 1^{st} TRIV is indicated by a time unit offset to a last actual indicated time unit in an immediate previous TRIV;
the N first resource locations are indicated by time unit offsets relative to the second reference location;
the first resource location of the 1^{st} TRIV is indicated based on the second reference location and/or a first time unit offset;
the first resource location of the 2^{nd} TRIV is indicated based on the second reference location and/or a second time unit offset; or
it is predefined in a protocol, preconfigured on a network, or configured on the network that the first resource location of the 1^{st} TRIV is an x^{th} time unit after the second reference location, where
L_{bit}, L1, L2, L3, N, and x are all positive integers.

In some embodiments, the first time unit offset is predefined in a protocol, preconfigured on the network, or configured on the network; and
the second time unit offset is predefined in a protocol, preconfigured on the network, or configured on the network.

In some embodiments, a maximum value of the first time unit offset is predefined in a protocol, preconfigured on the network, or configured on the network; or
a maximum value of the second time unit offset is predefined in a protocol, preconfigured on the network, or configured on the network.

In some embodiments, an index indication range of the first time unit offset includes all or a part of time unit locations within all or a part of DFNs; or
an index indication range of the second time unit offset includes all or a part of time unit locations within all or a part of DFNs.

In some embodiments, an index indication range of the second reference location includes all time unit locations within all DENs.

In some embodiments, the first resource location indication information meets at least one of the following:
N is equal to 2 or 3; or
the first resource location is indicated by a logical time unit offset relative to a second reference location.

In some embodiments, the second reference location is at least one of the following:
a location whose DFN is 0 and time unit index is 0;
the 1^{st} time unit location of a DEN in which the start time location of the resource selection window is located;
the start time location of the resource selection window;
a last actual indicated time unit in the 1^{st} TRIV;
a time location for transmitting the control information;
a location following, by M time units, the time location for transmitting the control information, where M is predefined in a protocol, preconfigured on a network, or configured on the network;
a start location of a resource selection period;
a last actual indicated time unit in an immediate previous TRIV; or
a first resource location of the immediate previous TRIV.

In some embodiments, a maximum value of the second reference location is predefined in a protocol, preconfigured on the network, or configured on the network.

In some embodiments, in a case that first resource locations of the first two TRIVs are indicated in a RIV form, a first resource location of the 3^{rd} TRIV is indicated by a time unit offset relative to a last actual indicated time unit in an immediate previous TRIV; or
in a case that first resource locations of last two TRIVs are indicated in a RIV form, a first resource location of the 1^{st} TRIV is indicated by a time unit offset relative to the second reference location.

In some embodiments,

$$RIV = \{ \begin{matrix}( K - 1 ) ( {t}_{2} - {t}_{1} - 1 ) + {t}_{1} + K & , {t}_{2} - {t}_{1} - 1 \leq ⌊ K / 2 ⌋ \\ ( K - 1 ) ( K - {t}_{2} + {t}_{1} ) + 2 ( K ) - {t}_{1} & , {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on a network, or configured on the network;
a time unit offset of an end time location of the resource selection window relative to the second reference location; or
the time unit offset of the end time location of the resource selection window relative to the second reference location minus processing time.

In some embodiments, in a case that N is equal to 2,

$$RIV = \{ \begin{matrix}( K - 1 ) ( {t}_{2} - {t}_{1} - 1 ) + {t}_{1} + K & , {t}_{2} - {t}_{1} - 1 \leq ⌊ K / 2 ⌋ \\ ( K - 1 ) ( K - {t}_{2} + {t}_{1} ) + 2 ( K ) - {t}_{1} & , {t}_{2} - {t}_{1} - 1 > ⌊ K / 2 ⌋\end{matrix}$$

t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on a network, or configured on the network;
a time unit offset of an end time location of the resource selection window relative to the second reference location; or
a time unit offset of the end time location of the resource selection window relative to the second reference location minus processing time.

In some embodiments, the first resource location indication information indicates first resource locations of two TRIVs in a RIV form.

In some embodiments, the first resource location indication information meets at least one of the following:
a first resource location of the 1^{st} TRIV is indicated by a time unit offset relative to a second reference location;
a first resource location of the 2^{nd} TRIV is indicated by a time unit offset relative to a last actual indicated time unit in the 1^{st} TRIV;
a first resource location of the 3^{rd} TRIV is indicated by a time unit offset relative to a last actual indicated time unit in the 2^{nd} TRIV;
first resource locations of two TRIVs are indicated by time unit offsets relative to the second reference location; or
t₁<t₂≤X, where X=2^{(B+1)/2}, t is the time unit offset of the first resource location of the 1^{st} TRIV relative to the second reference location, t₂ is a time unit offset of the first resource location of the 2^{nd} TRIV relative to the second reference location or the time unit offset of the first resource location of the 2^{nd} TRIV relative to the last actual indicated time unit in the 1^{st} TRIV, or is a time unit offset of the first resource location of the 3^{rd} TRIV relative to the second reference location or the time unit offset of the first resource location of the 3^{rd} TRIV relative to the last actual indicated time unit in the second TRIV, and B is a number that is of bits of a TRIV and that is preconfigured or configured on a network.

In some embodiments,

$$RIV = \{ \begin{matrix}( X - 1 ) ( {t}_{2} - {t}_{1} - 1 ) + {t}_{1} + X & , {t}_{2} - {t}_{1} - 1 \leq ⌊ X / 2 ⌋ \\ ( X - 1 ) ( X - {t}_{2} + {t}_{1} ) + 2 ( X ) - {t}_{1} & , {t}_{2} - {t}_{1} - 1 > ⌊ X / 2 ⌋\end{matrix}$$

In some embodiments, in a case that a first identifier in the control information indicates that the control information includes the coordination information, A^{th} to C^{th} bits in the control information are resource combination indication information; or when a first identifier in the control information indicates that the control information includes the request information, A^{th} to C^{th} bits in the control information include at least one of the following indication information:
start time location indication information of a resource selection window;
end time location indication information of the resource selection window;
indication information of a maximum number of reserved periods for resource selection;
indication information of a number of subchannels occupied by sending data; or
remaining PDB indication information.

According to the terminal provided in this embodiment of this application, a first terminal sends the control information to a second terminal, where the control information includes the request information and/or the coordination information. In this way, the request information and the coordination information are transmitted by occupying a small number of bits of the control information.

An embodiment of this application further provides a readable storage medium. The readable storage medium stores a program or instructions. When the program or the instructions are executed by a processor, various processes of the foregoing embodiments of the information transmission method are implemented, and the same technical effects can be achieved. To avoid repetition, details are not described herein again.

The processor is the processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface, and the communication interface is coupled to the processor. The processor is configured to run a program or instructions to implement the processes of the foregoing embodiments of the information transmission method, and the same technical effects can be achieved. To avoid repetition, details are not described herein again.

It should be understood that the chip in this embodiment of this application may also be referred to as a system-level chip, a system chip, a chip system, a system-on-a-chip, or the like.

An embodiment of this application further provides a computer program/program product, where the computer program/program product is stored in a storage medium. The computer program/program product is executed by at least one processor, to implement the processes of the foregoing embodiments of the information transmission method and achieve the same technical effects. To avoid repetition, details are not described herein again.

An embodiment of this application further provides an information transmission system, including: a terminal and a network-side device, where the terminal may be configured to perform the information transmission method as described above.

It should be noted that, the terms “include”, “comprise”, or any other variation thereof in this specification is intended to cover a non-exclusive inclusion, so that a process, method, object, or apparatus that includes a series of elements not only includes those elements, but also includes another element that is not clearly enumerated or an element inherent to the process, method, object, or apparatus. Without more limitations, an element defined by the sentence “including one . . . ” does not exclude a case that there is still another same element in a process, method, object, or apparatus including the element. Furthermore, it should be noted that in the scope of the method and apparatus in the embodiments of this application, the functions are not limited to being performed in the order shown or discussed, but may be performed basically simultaneously or in a reverse order. For example, the described method may be performed in an order different from the described order, and various steps may be added, omitted, or combined. In addition, features described with reference to some examples may be combined in other examples.

According to the descriptions in the foregoing implementations, a person skilled in the art may clearly learn that the methods in the foregoing embodiments may be implemented by using software and a commodity hardware platform or by using hardware. In many cases, the former is a better implementation. Based on such an understanding, the technical solutions of this application essentially, or the part contributing to the prior art, may be presented in a form of a computer software product. The computer software product is stored in a storage medium (for example, a ROM/RAM, a magnetic disk, or an optical disc), and includes several instructions to enable a terminal (which may be a mobile phone, a computer, a server, an air conditioner, a network device, or the like) to perform the methods described in the embodiments of this application.

Although the embodiments of this application are described above with reference to the accompanying drawings, this application is not limited to the implementations described above, and the implementations described above are merely examples and not limitations. A person of ordinary skill in the art may make various variations under the teaching of this application without departing from the spirit of this application and the protection scope of the claims, and such variations shall all fall within the protection scope of this application.

What is claimed is:

1. An information transmission method, comprising:
sending, by a first terminal, control information, wherein
the control information comprises request information or coordination information.

2. The information transmission method according to claim 1, wherein the control information comprises at least one of the following indication information:
resource selection window indication information;
start time location indication information of a resource selection window;
end time location indication information of the resource selection window;
indication information of a maximum number of reserved periods for resource selection;
indication information of a number of subchannels occupied by sending data;
remaining Packet Delay Budget (PDB) indication information; or
first resource location indication information.

3. The information transmission method according to claim 2, wherein the resource selection window indication information is determined by using at least one of the following:
a first reference location;
a start time location of the resource selection window;
an end time location of the resource selection window;
a third time unit offset, wherein the third time unit offset is a time unit offset relative to the start time location of the resource selection window or the first reference location; or
a Resource Indication Value (RIV).

4. The information transmission method according to claim 3, wherein the start time location or the end time location of the resource selection window is indicated by at least one of the following:
a Direct Frame Number (DFN);
a time unit index within a radio frame; or
a fourth time unit offset, wherein the fourth time unit offset is a time unit offset relative to the first reference location.

5. The information transmission method according to claim 4, where the first reference location is at least one of the following:
a location whose DFN is 0 and time unit index is 0;
the 1^{st} time unit location of a DFN in which the start time location of the resource selection window is located;
a time location for transmitting the control information; or
a location following, by M time units, the time location for transmitting the control information, wherein M is predefined in a protocol, preconfigured on a network, or configured on the network.

6. The information transmission method according to claim 2, wherein a resource selection window indicated by the resource selection window indication information meets at least one of the following:
a size that is of the resource selection window and that is predefined in a protocol, preconfigured on a network, or configured on the network is maximally Wₘₐₓ; or
a size that is of the resource selection window and that is predefined in a protocol, preconfigured on a network, or configured on the network is minimally Wₘᵢₙ,
wherein:
$${W}_{min} \leq L \leq T 1 + {W}_{max} - {T}_{start} ;$$
$$and$$
$${W}_{min} \leq L \leq T 1 - {T}_{start} ,$$
wherein:
L is a time unit offset, Wₘᵢₙ is a minimum value of the time unit offset, T1 is an indication range of 1024 radio frames, and Tₛₜₐᵣₜ is a start time location of the resource selection window.

7. The information transmission method according to claim 3, wherein the RIV is determined by using at least one of the following:
$$RIV = S ( L - {W}_{min} ) + {T}_{start} ;$$
$$RIV = L ;$$
$$RIV = \{ \begin{matrix}S ( L - {W}_{min} ) + {T}_{start} & , ( L - {W}_{min} ) \leq ⌊ S / 2 ⌋ \\ S ( S - L + {W}_{min} ) + ( S - 1 - {T}_{start} ) & , ( L - {W}_{min} ) > ⌊ S / 2 ⌋\end{matrix} ;$$
$$RIV = {W}_{max} {t}_{3} + {t}_{4} ;$$
$$RIV = {W}_{max} ( {t}_{4} - {t}_{3} - 1 ) + {t}_{3} ;$$
$$or$$
$$RIV = \{ \begin{matrix}( {W}_{max} - 1 ) ( {t}_{2} - {t}_{1} - 1 ) + {t}_{1} + {W}_{max} & , ( {t}_{2} - {t}_{1} - 1 ) < ⌊ {W}_{max} / 2 ⌋ \\ ( {W}_{max} - 1 ) ( {W}_{max} - {t}_{2} + {t}_{1} ) + 2 {W}_{max} - {t}_{1} & , ( {t}_{2} - {t}_{1} - 1 ) \geq ⌊ {W}_{max} / 2 ⌋\end{matrix} ,$$
wherein:
S=T1+Wₘₐₓ, T1 is an indication range of 1024 radio frames, Wₘₐₓ is a maximum value of a size of the resource selection window, L is a time unit offset, Tₛₜₐᵣₜ is the start time location of the resource selection window, Wₘᵢₙ is a minimum value of the size of the resource selection window, t₃ is a time unit offset of the start time location of the resource selection window relative to the first reference location, and t₄ is a time unit offset of the end time location of the resource selection window relative to the first reference location.

8. The information transmission method according to claim 2, wherein the first resource location indication information indicates first resource locations of N Time Resource Indication Values (TRIVs), wherein N is a positive integer.

9. The information transmission method according to claim 8, wherein the first resource location indication information meets at least one of the following:
a number that is of bits of the first resource location indication information and that is predefined in a protocol is L_{bit}; and in the first resource location indication information, a number of bits indicating a first resource location of the 1^{st} TRIV is L1, a number of bits indicating a first resource location of the 2^{nd} TRIV is L2, and a number of bits indicating a first resource location of the 3^{rd} TRIV is L3, wherein L1+L2+L3=L_{bit};
the first resource location of the 1^{st} TRIV is indicated by a time unit offset relative to a second reference location, and a first resource location of a TRIV other than the 1^{st} TRIV is indicated by a time unit offset to a last actual indicated time unit in an immediate previous TRIV;
the N first resource locations are indicated by time unit offsets relative to the second reference location;
the first resource location of the 1^{st} TRIV is indicated based on the second reference location or a first time unit offset;
the first resource location of the 2^{nd} TRIV is indicated based on the second reference location and/or a second time unit offset; or
it is predefined in a protocol, preconfigured on a network, or configured on the network that the first resource location of the 1^{st} TRIV is an x^{th} time unit after the second reference location, wherein
L_{bit}, L1, L2, L3, N, and x are all positive integers.

10. The information transmission method according to claim 9, wherein the first time unit offset is predefined in a protocol, preconfigured on the network, or configured on the network; and
the second time unit offset is predefined in a protocol, preconfigured on the network, or configured on the network.

11. The information transmission method according to claim 9, wherein a maximum value of the first time unit offset is predefined in a protocol, preconfigured on the network, or configured on the network; or
a maximum value of the second time unit offset is predefined in a protocol, preconfigured on the network, or configured on the network.

12. The information transmission method according to claim 9, wherein:
an index indication range of the first time unit offset comprises all or a part of time unit locations within all or a part of DFNs; or
an index indication range of the second time unit offset comprises all or a part of time unit locations within all or a part of DFNs.

13. The information transmission method according to claim 9, wherein an index indication range of the second reference location comprises all time unit locations within all DFNs.

14. The information transmission method according to claim 8, wherein the first resource location indication information meets at least one of the following:
N is equal to 2 or 3; or
the first resource location is indicated by a time unit offset relative to a second reference location.

15. The information transmission method according to claim 9, wherein the second reference location is at least one of the following:
a location whose DFN is 0 and time unit index is 0;
the 1^{st} time unit location of a DFN in which a start time location of the resource selection window is located;
the start time location of the resource selection window;
a last actual indicated time unit in the 1^{st} TRIV;
a time location for transmitting the control information;
a location following, by M time units, the time location for transmitting the control information, wherein M is predefined in a protocol, preconfigured on a network, or configured on the network;
a start location of a resource selection period;
a last actual indicated time unit in an immediate previous TRIV; or
a first resource location of the immediate previous TRIV.

16. The information transmission method according to claim 9, wherein a maximum value of the second reference location is predefined in a protocol, preconfigured on the network, or configured on the network.

17. The information transmission method according to claim 14, wherein
when first resource locations of the first two TRIVs are indicated in a RIV form, a first resource location of the 3^{rd} TRIV is indicated by a time unit offset relative to a last actual indicated time unit in an immediate previous TRIV; or
when first resource locations of last two TRIVs are indicated in a RIV form, a first resource location of the 1^{st} TRIV is indicated by a time unit offset relative to the second reference location.

18. The information transmission method according to claim 17, wherein
$$RIV = \{ \begin{matrix}( K - 1 ) ( {t}_{2} - {t}_{1} - 1 ) + {t}_{1} + K & , {t}_{2} - {t}_{1} - 1 \leq ⌊ K / 2 ⌋ \\ ( K - 1 ) ( K - {t}_{2} + {t}_{1} ) + 2 ( K ) - {t}_{1} & , {t}_{2} - {t}_{1} - 1 > ⌊ K / 2 ⌋\end{matrix} ,$$
wherein: t₂ is a time unit offset of a first resource location of an immediate subsequent TRIV relative to the second reference location in time domain, t₁ is a time unit offset of a first resource location of an immediate previous TRIV relative to the second reference location in time domain, t₁<t₂≤K, and K is at least one of the following:
a value predefined in a protocol, preconfigured on a network, or configured on the network;
a time unit offset of an end time location of the resource selection window relative to the second reference location; or
the time unit offset of the end time location of the resource selection window relative to the second reference location minus processing time.

19. A terminal, comprising: a processor; and a memory having a computer program or an instruction stored thereon, wherein the computer program or the instruction, when executed by the processor, causes the processor to implement operations, comprising:
sending control information, wherein the control information comprises request information or coordination information.

20. A non-transitory computer-readable storage medium storing a computer program or an instruction that, when executed by a processor, causes the processor to implement operations, comprising:
sending control information, wherein the control information comprises request information or coordination information.
